(19) United States
(12) Patent Application Publication
(10) Pub. No.: US 2017/0166086 A1
(43) Pub. Date: Jun. 15, 2017

(54) METHOD AND DEVICE FOR GENERATING A SIGNAL REPRESENTING AN OCCUPATION OF A VEHICLE SEAT, CORRESPONDING COMPUTER PROGRAM, AND MACHINE-READABLE STORAGE MEDIUM

(71) Applicant: Robert Bosch GmbH, Stuttgart (DE)

(72) Inventors: Gian Antonio D'Addetta, Stuttgart (DE); Joerg Moennich, Stuttgart (DE); Thomas Lich, Esslingen (DE)

(21) Appl. No.: 15/117,084

(22) PCT Filed: Feb. 6, 2015
(86) PCT No.: PCT/EP2015/052553

§ 371 Date: Aug. 5, 2016

(30) Foreign Application Priority Data
Feb. 6, 2014 (DE) 10 2014 202130.8

(51) Int. Cl. B60N 2/00; G08B 21/22

(52) U.S. Cl. CPC B60N 2/002; G08B 21/22

(57) ABSTRACT

A method for generating a signal representing an occupation of a vehicle seat of a vehicle including the steps: detecting a signal of a sensor system for detecting a dynamic parameter with respect to the vehicle seat; evaluating the signal, in particular, a progression of the signal; generating a seat occupancy signal as a function of the evaluation of the signal, the seat occupancy signal being suited for indicating whether the vehicle seat is occupied by a person or by an object.

### BACKGROUND INFORMATION

Since the introduction of statutory mandatory seat belt use in Germany in 1977 and the introduction of seat belts in the 1970s, the number of those killed was able to be reduced from 21,000 to less than 4,000. In addition to other restraint systems, the seat belt primarily provides, with approximately 75%-80% of the restraint effect, the largest contribution to protecting the occupant in the case of an accident.

The possibilities for manipulating the present systems are unlimited. It is alarming, for example, that increasingly more car owners have the corresponding seat belt reminders shut off on the software side in specialist workshops at their own expense and risk, and to the exclusion of the manufacturer's liability.

The percentage of seat belt use and the relevance thereof to the percent proportion of the non-belted, vehicle occupants who were killed in 2010 illustrates the above-mentioned connection. It is clear that in the Federal Republic of Germany in 2010, one in five occupant mortalities result from not using seat belts.

Particular relevance of this topic also relates to the USA. In a response to a petition from August 2013 [Doc. 2013-21128 and 2013-0095], the NHTSA states that approximately 200 lives are saved annually by the use of seat belts during traffic accidents. It has been shown that the percentage of seat belt use in the USA in 2012 was approximately 86%; still, the remaining 14% were unbelted and thus also potentially at risk of a fatal accident during a collision.

Seat occupancy detection devices generally check on the basis of whether the belt buckle is inserted in the occupied seat, i.e., whether the preferably metal tongue of the belt system is engaged in the seat belt lock. Based on this, the driver is warned, mostly by acoustic, optical, or visual signals that one or multiple occupants of the vehicle are not correctly buckled up or not buckled up at all. Manipulation of the system is, however, still possible, for example, by guiding the seat belt behind the occupied seat or behind the backrest of the occupied seat and inserting the belt buckle, or by using dummy seat belt tongues. It may thus be concluded that occupants of European vehicles, or of vehicles for the European market, who do not buckle up, may also not profit from the significantly increased safety levels of the vehicles. Crash loads may not be reduced by the irreversible, pyrotechnic belt tensioners, introduced for the first time in 1985, nor do these occupants profit from the increasingly used pre-crash systems.

The need for a sustainable “motivation” for these so-called “seat belt shirkers” to use the seat belt is obvious from moral and consumer protection reasons. The experiences in other European countries show that, even with a significant increase in fines, a “saturation level” is reached and a number of occupants in the low double digits or high single digit percentages remains who continue to not buckle up. However, expanded technological possibilities may be used in advantageous ways to achieve the highest level of seat belt use by vehicle occupants.

One possibility for identifying a successful and correct seat belt use includes the use of the belt retraction length. Alternatively, optical methods may be used for recognizing the seat belt buckling state, which may also be used, e.g., to determine the position of the occupants. However, the present stage of development in optical methods for interior sensor systems does not yet allow an optical detection as to whether the driver is correctly buckled up, or buckled up at all.

The problem in all of the methods described above is the fact that the actual seat position in the field is not considered or is granted only minor consideration. Thus, a proper detection of the seat belt fastening state is difficult from the information about the belt retraction length. As a whole, it is common in all of the listed and known systems, that neither the belt retraction length nor belt force information are used for a belt reminder warning and/or blocking function.

A system is described in German Patent Application No. DE 10 2008 042399, which carries out a detection of a so-called belt-misuse state, i.e., the pretense of a correctly inserted belt, based on interior sensor systems, e.g., belt retraction length information from the belt automatic controller, seat belt lock switches, a seat occupancy detection, and power-on information from the vehicle.

A system is described in German Patent Application No. 10 2010 029790, which detects the buckled-up condition with the aid of an angle measuring principle at the lower deflection point (belt anchor point or belt anchoring point between the belt system and the restraining system at the vehicle structure/chassis or vehicle seat). This principle is based on an angle measurement by a contact sensor or another angle measuring sensor. The need may thereby arise to carry out a measurement with the aid of a noncontact sensor, as other sensor requirements are necessary due to the available installation space.

Conventional variants for “outsmarting” a presently common belt warning system with sensors in the belt buckle or retraction length detection and seat occupancy detection (seat mat) are listed as follows:

1. deactivating the system by, for example, a garage
2. using a “dummy belt tongue” (see FIG. 4)
3. inserting the belt and subsequently sitting on the seat belt (see FIG. 5)
4. guiding the seat belt behind the seat back (see FIG. 6)
5. inserting the belt of an unused seat (see FIG. 7)
6. using a retraction length clamp (see FIG. 8)

The table in FIG. 9 comparatively shows the ability of the different systems to detect this with respect to the types of incorrect seat belt use and refers to the related art.

Many people will not use variant 3, “inserting the belt and subsequently sitting on the seat belt,” since the seating comfort suffers significantly. A deactivation by the garage, according to variant 1, might be limited by legal regulations (e.g. check during general vehicle inspection).

The “misuse/use” cases presented in the table in FIG. 9 may be detected by conventional systems. A further usage case, however, has not yet been considered:

What happens when someone places an object, e.g., a guitar case, a heavy case, or something else, on the front seat, and does not buckle it up?

### SUMMARY

The present application relates to the previously described use case; namely, the placing of a heavy object on the front seat without carrying out a belt-fastening process.

One goal is that, even when omitting the belt-fastening process, the warning function or seat belt interlock function is not activated, since a person does not occupy the affected seat. The system (warning function/interlock) is to be “comfortably” configured so that a warning/blocking is carried out only in the case of an incorrectly or not buckled up person, and a warning/blocking is not carried out in the case of objects (similar to persons in the sense of weight or shape).

It may therefore be considered an object of the present invention to unambiguously identify a seat occupied only by an object and not by a person, and consequently no interruption of the engine output or prevention of the starting process (blocking) is carried out.

It may thus be considered a further object of the present invention to carry out a decision for the underlying use case whether a person or a non-person (for example, an object) occupies a seat, without using a seat belt sensor system.

This object may be achieved by a method and a device for generating a signal representing an occupation of a vehicle seat, a corresponding computer program, and a machine-readable storage medium according to the present invention.

Therefore, the ascertainment of the object is carried out on the basis of dynamic parameters from a sensor system integrated into the seat or proximate to the seat. The sensor system may thereby be, for example, a weight sensor system on the basis of absolute weight measurement, but also a seat mat-based approach or also based on a capacity measurement from a sensor system installed in the seat or in the roof lining. Sensors are likewise possible which are installed in the headrest or in the center armrest.

The basis for the method is the evaluation of the respective parameters from the sensor system integrated into or proximate to the seat. The parameters are typically measured force-time progressions; however, current-time progressions are also used depending on the type of sensor system. The different characteristics of a seated person in comparison to an object placed on the seat are thereby addressed. These characteristics differ in the seating process, i.e., directly at the state transition from “seat unoccupied” to “seat occupied” and also in the first driving state, e.g., from the start up to the speed of a “throttling process” (for example, caused by a seatbelt interlock system upon recognizing a person). Influencing factors on these characteristics are the different inertial effects even at the same mass; however, a significantly different pattern is also caused by the active muscle tensioning and uneven weight distribution of a person.

Advantageous embodiments of the present invention arise from the description below of exemplary embodiments.

### BRIEF DESCRIPTION OF THE DRAWINGS

FIG. 1 shows an actual traffic accident, deadly consequences of an accident due to incorrect seat belt use (belt guided behind).

FIG. 2 shows an example of incorrect seat belt use; belt anchoring using the shaft connected to the B column and the sillboard.

FIG. 3 shows an example of incorrect seat belt use; belt anchoring using the swivel joint connected to the B column.

FIG. 4 shows a “dummy belt tongue” to deactivate the fasten-seat belt sign (incorrect seat belt use), variant 2.

FIG. 5 shows “sitting on the belt”, variant 3.

FIG. 6 shows guiding the belt behind the seatback, variant 4.

FIG. 7 shows inserting an unused seat belt (passenger), variant 5.

FIG. 8 shows a “belt retraction clamp”, variant 6.

FIG. 9 shows recognizability of the different systems with respect to the types of incorrect seat belt use and previously registered or published principles.

FIG. 10 shows a pattern comparison of different seat occupancies.

FIG. 11 shows a block diagram of a first simple embodiment variant.

FIG. 12 shows a block diagram—coupling of different pieces of sensor information.

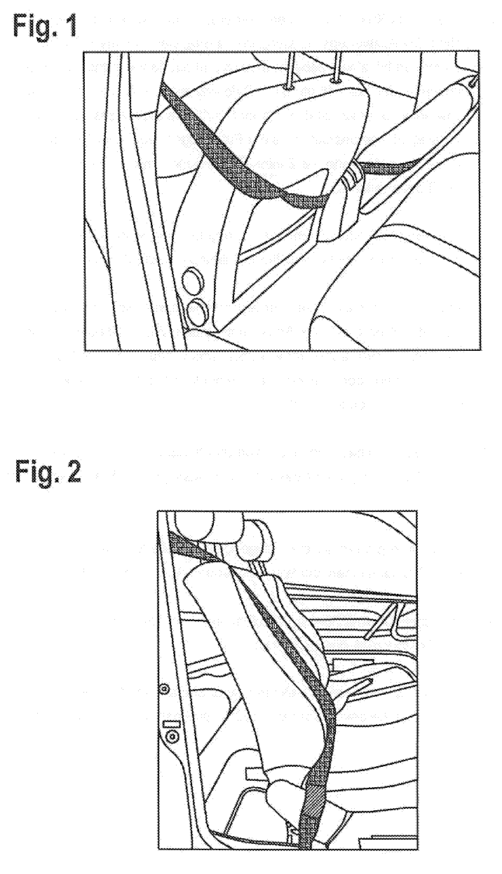

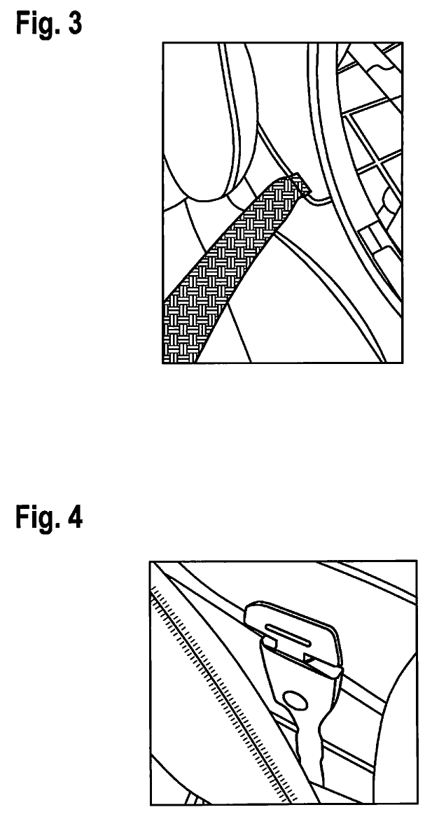

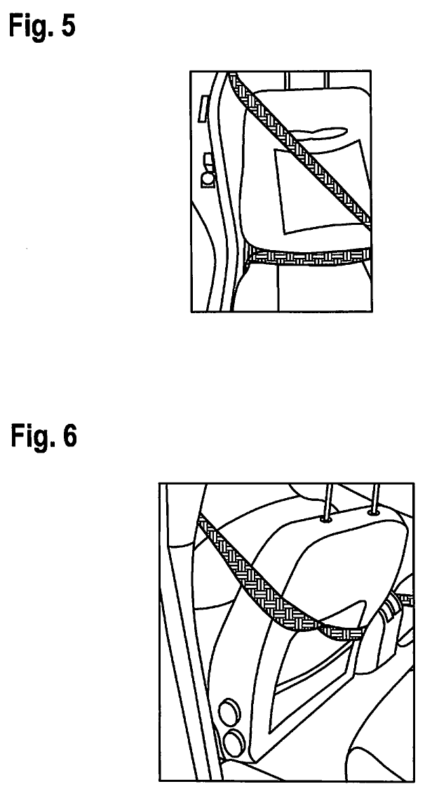

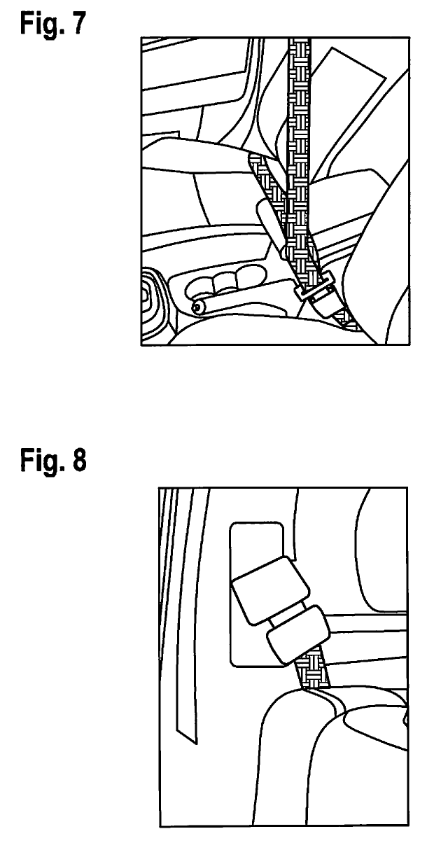

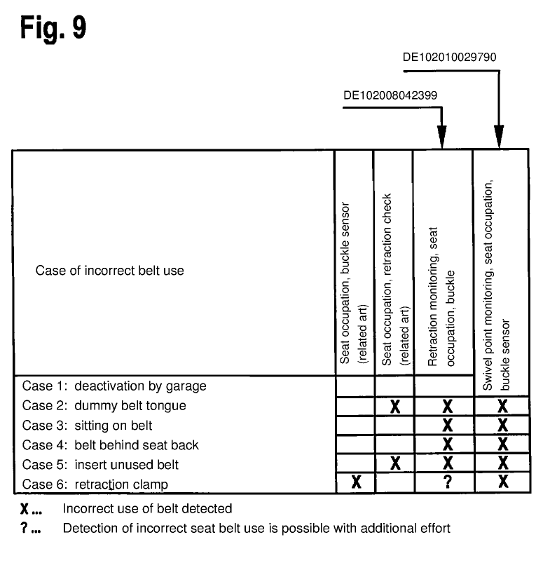

### DETAILED DESCRIPTION OF EXAMPLE EMBODIMENTS

In a first implementation variant, the detection as to whether an object or a person occupies the seat is carried out by evaluating the seating process, e.g., prior to the start of the ignition yet after opening the vehicle or one of the vehicle doors. The value provided by the sensor system integrated in the seat or proximate to the seat during the initialization, thus after the power on, is, for example, 1000. All subsequently represented values relate to this reference value. The initialization is no longer carried out in modern vehicles after ignition; instead a (partial) energization is carried out already at the opening of the vehicle (for example, via a remote opening of the vehicle). The following context thus arises for a first possible implementation, under the precondition that an energization of the sensor system integrated in the seat or proximate to the seat may be carried out and that this delivers a force, current, or other value:

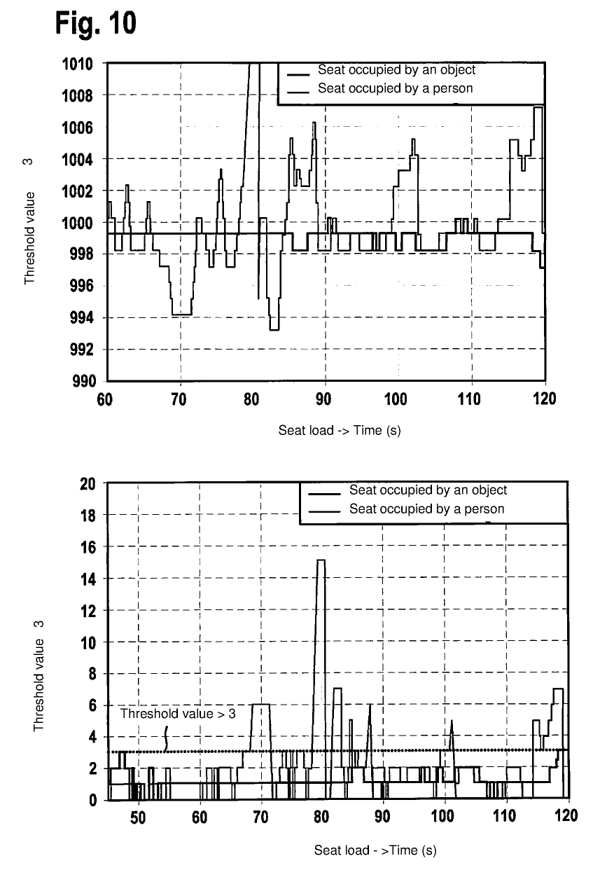

In a seating process, each occupant assumes a pattern typical for him/herself, which is additionally dependent on the position of the seat relative to the instrument panel and on the individual person (body proportions). This case differs significantly from the exemplary use case of a loading on the seat by an object, compare FIG. 10.

The measurements represented schematically in FIG. 10 show a differentiation possibility using a simple threshold comparison. A possible evaluation provides for forming the difference to the initial value, for calculating the absolute value therefrom, and querying via a threshold value. At each exceedance of the threshold value, a counter is incremented, which is then likewise queried via another threshold value, and a corresponding status flag is generated. In the example, the threshold value 3 has been determined in this case. As is clear from this, an immediate evaluation is not possible, but instead requires the presence of a certain number of sequential measuring points. The differentiation is, however, clear, so that a differentiation between the use case “object” and “person” may be safely carried out. The influence of different scanning variations, at correspondingly low scanning, may be addressed by additional weighting.

It should be noted that a simple threshold value query is insufficient. The separation in the area around the two values must be considered as measurement noise and tolerance. Therefore, a dynamic evaluation is required to enable an observation of the relative variable.

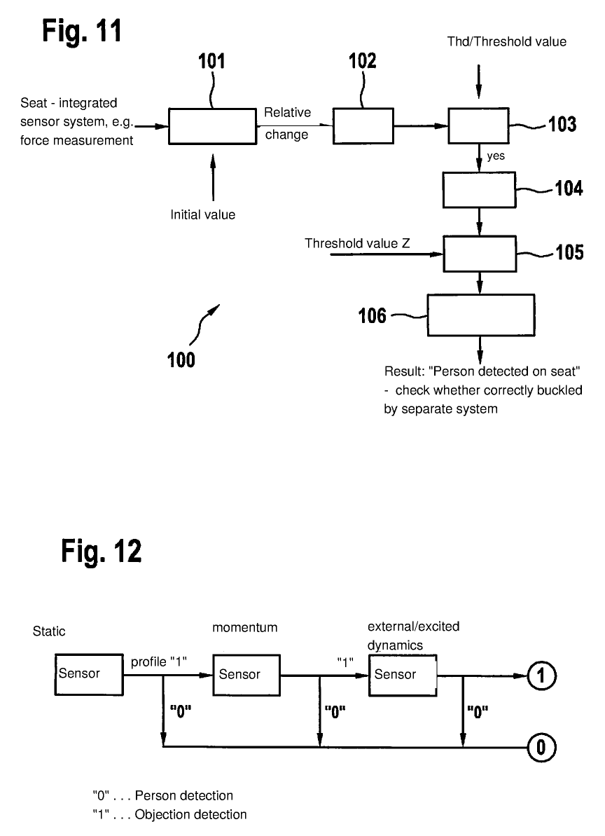

A flow chart for a variant of the method of the present invention is shown in FIG. 11. In this case, no vehicle dynamics information, such as speed or vehicle longitudinal deceleration, is used. As a result, the piece of information is used as an input value for a check whether a correct belt-fastening process is present, i.e., it must be checked, if a person has been detected on the seat instead of an object, whether this person is correctly buckled up. If an object has been detected, this is not carried out.

For this purpose, differences between a predetermined initial value and the sensor signal of a sensor system integrated into the seat are initially formed in step 101. These differences are delivered as relative changes to step 102.

In step 102, an absolute value generation of the formed difference is then carried out.

The absolute value is compared to a first predetermined threshold value in step 103. In one embodiment variant, the first predetermined threshold value may be changed. In the flow chart, this is represented by the input arrow with the designation “Thd/threshold value.” An increment of a counter is carried out in step 104 each time the threshold value has been exceeded by the absolute value.

The counter content is compared to a second predetermined threshold value in step 105. In one embodiment variant, the second predetermined threshold value may be changed. In the flow chart, this is represented by the input arrow with the designation “threshold value Z.”

Depending on the threshold value comparison in step 105, the generation of a signal is carried out in step 106 which is suited for the purpose of indicating whether the vehicle seat is occupied by a person or by an object. This signal may be forwarded via a suitable communication interface, for example, via a CAN bus, to other components in the vehicle, for example, to a system which checks whether a seatbelt system for the vehicle seat is correctly fastened, if it has been detected that the vehicle seat is occupied by a person.

One supplemental embodiment provides for the consideration of additional vehicle dynamics information, e.g., the speed or acceleration information. The algorithm is thereby only carried out if the speed lies over or under a defined threshold value. It is likewise conceivable to only carry out situationally adaptive evaluations, during which a high dynamic of the occupants or objects is to be expected, for example, during acceleration and/or during braking. This would lead, under the circumstances, to an increase in the stability of the approach. The vehicle dynamics information, already available, for example, on the CAN bus, is evaluated in the present invention for this purpose as additional input. As base information, the vehicle speed and, if available, the longitudinal acceleration (ax) are used. Thus, a dynamic observation is enabled.

A possible supplement uses the vehicle dynamics sensor systems and includes in one embodiment vehicle dynamics variables, such as, for example, speed or acceleration in the longitudinal direction. An expansion using vehicle dynamics variables, such as accelerations in all three spatial directions, rotation rates in all three spatial directions, wheel speeds, brake pressure(s) of the individual wheels, steering wheel or steering angle information at the wheel, brake and gas pedal position, is likewise possible and thus increases the robustness of the evaluation.

An additional implementation variant is based on the storage of the last state/status of the sensor information upon shut-off of the vehicle. For example, storing a value or even a value profile in a suitable control unit would be possible. Upon restart of the vehicle, a comparison of the dynamics information according to the previously described method to the stored values or value profiles is carried out. It may be concluded therefrom that a “rigid” load/object is present when there is no change, since a human occupant would always behave differently and would not remain static over a longer period.

A general flow chart, with consideration of different pieces of sensor information, is shown in FIG. 12. For example, the sensor for static and dynamic measurement may be a piece of image information with subsequent object detection (e.g. interior camera), a thermal profile, a noise profile, a piece of weight information (e.g., sensor system integrated into the seat). The sensor system for detecting an external excitation includes the measurement of a reaction of an object or a person to an external excitation, for example, “bumping” due to seat kinematics and/or driving dynamics and/or vehicle dynamics (braking/acceleration).

In addition to vehicle dynamics information, additional measured variables or states provided for other functions may be used for plausibility checks or threshold value adjustment. For example, microswitches in the door handle may detect whether the door is opened/closed from inside or outside. Also, an operation of the seat adjustment when the door is closed and on the seat side facing away from the driver leads to a conclusion of a person sitting on the seat.

A determination may be carried out in a control unit, such as, e.g., the airbag control unit. Other control units with corresponding communication options, such as a CAN bus, are likewise possible (e.g., seat or door control units), since these are not time-critical evaluations. Control of other components of the vehicle, for example, the starter motor, is likewise conceivable.

The protection of the individual person in street traffic is an overriding advantage of the invention, since a typical application of an appropriate use distinguishes loading the seat with an object from a much more typical application of a sitting vehicle occupant. An additional advantage lies in the fact that the functionality “object on the seat without buckling it up” is enabled and allowed. Otherwise, the object must always be mandatorily buckled up. Lack of such a function would have far-reaching consequences, in particular in the USA, with regard to the acceptance of such a device or such a method.

Additional advantages over the related art:
In the case of an accident, upon detection of a load (i.e., not a person), triggering of unnecessary restraining means may be suppressed, for example, in order to prevent repair costs. Also, an unintentional acceleration of the load (e.g., due to airbag triggering) may thus be prevented.
In the case of an accident, upon detection of a load, corresponding restraining means specific to load protection/protection of occupants from the load may be reparameterized or in order to prevent the load from flying about (for example, changed airbag triggering with respect to occupants).
The device provides a cost efficient alternative to interior cameras.

1-13. (canceled)

14. A method for generating a signal representing an occupation of a vehicle seat of a vehicle, comprising:
detecting a signal of a sensor system for detecting a dynamic parameter with respect to the vehicle seat;
evaluating a progression of the signal; and
generating a seat occupancy signal as a function of the evaluation of the signal, the seat occupancy signal for indicating whether the vehicle seat is occupied by a person or by an object.

15. The method as recited in claim 14, wherein the sensor system detects a force measurement and the parameter represents at least one of a force-time progression and a current-time progression.

16. The method as recited in claim 14, wherein the method is carried out only if the speed of the vehicle falls short of or exceeds a predetermined speed threshold value.

17. The method as recited in claim 15, wherein the progression of the parameter during a seating process is evaluated from a period after opening the vehicle and prior to a start of an ignition of the vehicle.

18. The method as recited in claim 15, wherein the progression of the parameter is evaluated during a first driving state from a start-up of the vehicle to a speed of a throttling process of the vehicle.

19. The method as recited in claim 14, wherein the method is carried out only if a high dynamic of the object or the person occupying the vehicle seat is to be expected.

20. The method as recited in claim 14, wherein the method is carried only at least one of: during acceleration of the vehicle and during braking of the vehicle.

21. The method as recited in claim 14, wherein differences of the detected signal to a predetermined initial value are formed in the evaluating step, and a counter is incremented each time when an absolute value of the difference exceeds a predetermined first threshold value, a seat occupancy signal being generated, which indicates that the vehicle seat is occupied by a person, in the step of generating, when the counter exceeds a second predetermined threshold value.

22. The method as recited in claim 21, wherein the difference formation is carried out in a weighted manner in the step of evaluating.

23. The method as recited in claim 14, wherein a comparison with at least one of a value and a value profile is carried out in the step of evaluating, which represents at least one of a state and a status of the evaluation during a preceding shut-off of the vehicle.

24. The method as recited in claim 14, wherein a status flag is set as the seat occupation signal in the step of generating.

25. A non-transitory machine-readable storage medium on which is stored a computer program for generating a signal representing an occupation of a vehicle seat of a vehicle, the computer program, when executed by a computer, causing the computer to perform:
detecting a signal of a sensor system for detecting a dynamic parameter with respect to the vehicle seat;
evaluating a progression of the signal; and
generating a seat occupancy signal as a function of the evaluation of the signal, the seat occupancy signal for indicating whether the vehicle seat is occupied by a person or by an object.

26. An electronic control unit for generating a signal representing an occupation of a vehicle seat of a vehicle, the computer program, the electronic control unit configured to:
detect a signal of a sensor system for detecting a dynamic parameter with respect to the vehicle seat;
evaluate a progression of the signal; and
generate a seat occupancy signal as a function of the evaluation of the signal, the seat occupancy signal for indicating whether the vehicle seat is occupied by a person or by an object.
